(19) United States
(12) Patent Application Publication
(10) Pub. No.: US 2017/0291373 A1
(43) Pub. Date: Oct. 12, 2017

(54) THREE-DIMENSIONAL OBJECT MANUFACTURING SYSTEM AND THREE-DIMENSIONAL OBJECT MANUFACTURING METHOD

(71) Applicant: MIMAKI ENGINEERING CO., LTD., NAGANO (JP)

(72) Inventor: HIROFUMI HARA, NAGANO (JP)

(73) Assignee: MIMAKI ENGINEERING CO., LTD., NAGANO (JP)

(21) Appl. No.: 15/481,470

(22) Filed: Apr. 7, 2017

(30) Foreign Application Priority Data
Apr. 8, 2016 (JP) 2016-078461
Feb. 24, 2017 (JP) 2017-032784

(51) Int. Cl. B29C 67/00; B33Y 30/00; B33Y 50/02; B33Y 10/00

(52) U.S. Cl. CPC B29C 67/0092; B29C 67/0088; B33Y 10/00; B33Y 30/00; B33Y 50/02

(57) ABSTRACT

A three-dimensional object manufacturing system includes a three-dimensional structural object manufacturing device, a packing material manufacturing device, and a control device. The three-dimensional structural object manufacturing device manufactures a three-dimensional object based on molding data of the three-dimensional object. The packing material manufacturing device manufactures a shock absorbing material that is disposed at a periphery of the three-dimensional object and that is detachably attached to the three-dimensional object. The control device calculates the shape of the shock absorbing material based on the molding data of the three-dimensional object.

### CROSS REFERENCE TO RELATED APPLICATIONS

This application claims the priority benefit of Japanese Patent Application No. 2016-078461, filed on Apr. 8, 2016 and Japanese Patent Application No. 2017-032784, filed on Feb. 24, 2017. The entirety of the above-mentioned patent applications are hereby incorporated by reference herein and made a part of this specification.

### TECHNICAL FIELD

The present disclosure relates to a three-dimensional object manufacturing system and a three-dimensional object manufacturing method.

### DESCRIPTION OF THE BACKGROUND ART

A three-dimensional printer referred to as a so-called 3D printer that manufactures a three-dimensional object is recently being developed. A three-dimensional printer and a three-dimensional object manufacturing method that shapes a three-dimensional object by stacking a molding material such as discharged ink, and the like, for example, are known for the 3D printer. For example, a three-dimensional printer described in Japanese Patent No. 4420685 divides three-dimensional data of an object into a plurality of layers, discharges a molding material from a discharging portion in order from a lowermost layer, and then cures and stacks the molding material to shape an object complying with the three-dimensional data. A three-dimensional molding device includes an inkjet type head that discharges ink serving as a molding material. The three-dimensional printer described in Japanese Patent No. 4420685 uses an ultraviolet curable ink for the molding material, and irradiates the discharged and landed ultraviolet curable ink with an ultraviolet light from a curing portion to cure the ultraviolet curable ink. Other than the inkjet method using the curing type ink, the 3D printer may also adopt a method of dissolving a filament for molding (FDM), a plaster method of curing powder plaster with an adhesive, an optical shaping method of irradiating a liquid tank of optically shaping resin with curing light, and the like.

### SUMMARY

A three-dimensional object manufactured with the 3D printer is in a state where a thin portion and the like easily break. Thus, even if the three-dimensional structural object is placed in a box and a protective member such as a shock absorbing material is disposed at the periphery thereof, a large force may be exerted on one part thus causing breakage if the disposition of the protective member is uneven.

In light of the foregoing, the present disclosure provides a three-dimensional object manufacturing system and a three-dimensional object manufacturing method capable of easily manufacturing a three-dimensional object and a member for protecting the three-dimensional object.

In order to solve the problem described above and to achieve the goal, the present disclosure provides a three-dimensional object manufacturing system including a three-dimensional structural object manufacturing device that manufactures a three-dimensional object based on molding data of the three-dimensional object; a packing material manufacturing device that manufactures a shock absorbing material that is disposed at a periphery of the three-dimensional object and that is detachably attached to the object; and a control device that calculates a shape of the shock absorbing material based on the molding data of the three-dimensional object.

Thus, the three-dimensional structural object can be appropriately protected by creating the protective member for protecting the three-dimensional object based on the three-dimensional data for manufacturing the three-dimensional object. This allows transportation while maintaining the shape of the three-dimensional object.

The control device preferably causes the shape of the shock absorbing material to be a shape that covers an entire periphery of the three-dimensional object.

The three-dimensional object thus can be reliably protected with the shock absorbing material.

The control device preferably calculates a first outer shape of a distance set from the three-dimensional object based on the shape data of the three-dimensional object, and carries out a smoothing process on the first outer shape; and calculates a second outer shape, and calculates the shape of the shock absorbing material based on the second outer shape.

The shock absorbing material thus can be easily manufactured.

The control device preferably causes the shape of the shock absorbing material to be a shape in which one part of the shock absorbing material and the three-dimensional structural object make contact based on the molding data of the three-dimensional object.

The three-dimensional object thus can be reliably supported with the shock absorbing material, and the three-dimensional object can be more reliably protected.

The control device preferably calculates a shape of a plate-shaped shock absorbing material of each layer with the shape of the shock absorbing material as a shape in which the plate-shaped shock absorbing material is stacked in plurals; and the packing material manufacturing device manufactures the plate-shaped shock absorbing material for a plurality of layers based on the shape of the shock absorbing material calculated by the control device.

The shock absorbing material thus can be easily manufactured, and the shock absorbing material can be easily arranged at the periphery of the three-dimensional object.

In order to solve the problem described above and to achieve the goal, the present disclosure also provides a three-dimensional object manufacturing method including a three-dimensional structural object manufacturing step of manufacturing a three-dimensional object based on molding data of the three-dimensional object; a calculating step of calculating a shape of a shock absorbing material that is disposed at a periphery of the three-dimensional object and that is detachably attached to the three-dimensional object, based on the molding data of the three-dimensional object; and a shock absorbing material manufacturing step of manufacturing the shock absorbing material based on the calculated shape of the shock absorbing material.

Thus, the three-dimensional structural object can be appropriately protected by creating the protective member for protecting the three-dimensional object based on the three-dimensional data for manufacturing the three-dimensional object. This allows transportation while maintaining the shape of the three-dimensional object.

According to the present disclosure, the three-dimensional structural object can be appropriately protected by creating the protective member for protecting the three-dimensional object based on the three-dimensional data for manufacturing the three-dimensional object. This has an effect of being able to transport while maintaining the shape of the three-dimensional object.

### BRIEF DESCRIPTION OF THE DRAWINGS

FIG. 1 is a schematic view showing a general configuration of a three-dimensional object manufacturing system.

FIG. 2 is a schematic view showing a general configuration of an inkjet printer.

FIG. 3 is a schematic view showing a general configuration of a packing material manufacturing device.

FIG. 4 is a schematic view showing a configuration of each section of the packing material manufacturing device.

FIG. 5 is a schematic view showing a general configuration of a control device.

FIG. 6 is a flowchart showing one example of a processing operation of a three-dimensional object manufacturing system.

FIG. 7 is a flowchart showing one example of a method for manufacturing a three-dimensional object.

FIG. 8 is a flowchart showing one example of a method for manufacturing a shock absorbing material.

FIG. 9 is an explanatory view describing the method for manufacturing the shock absorbing material.

FIG. 10 is an explanatory view describing the method for manufacturing the shock absorbing material.

FIG. 11 is an explanatory view describing the method for manufacturing the shock absorbing material.

FIG. 12 is a flowchart showing one example of a method for manufacturing a container box.

### DETAILED DESCRIPTION OF EMBODIMENT

Hereinafter, an embodiment of a three-dimensional object manufacturing system and a three-dimensional object manufacturing method according to the present disclosure will be described in detail based on the drawings. It should be noted that the present disclosure is not limited by this embodiment. Components in the following embodiment include components that can be replaced by those skilled in the art and are easy, or are substantially the same.

### Embodiment

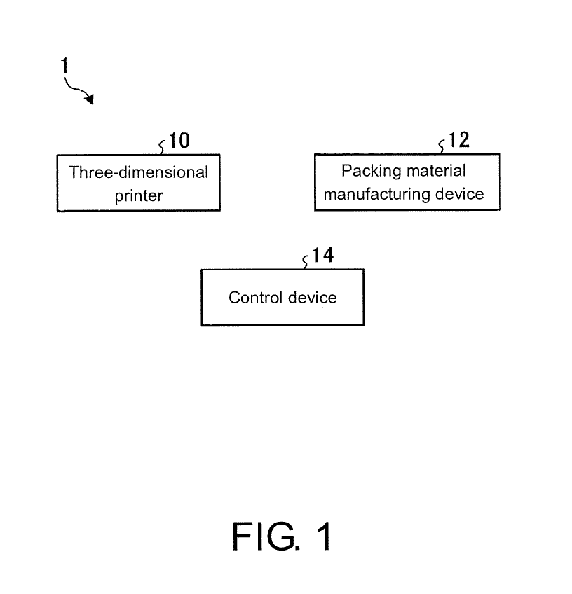

FIG. 1 is a schematic view showing a general configuration of a three-dimensional object manufacturing system. A three-dimensional object manufacturing system 1 shown in FIG. 1 is a system that manufactures both a three-dimensional object and a packing material for packing the manufactured three-dimensional object. The packing material includes a container box for accommodating the three-dimensional object, and a shock absorbing material (protective member) disposed between the container box and the three-dimensional object. The shock absorbing material is a material softer than the three-dimensional object, and is, for example, a sponge. The shock absorbing material has a plate shape, and includes a recess corresponding to the three-dimensional object by stacking a shock absorbing material formed with a cutout or a space corresponding to the three-dimensional object at each position.

The three-dimensional object manufacturing system 1 includes a three-dimensional printer 10, a packing material manufacturing device 12, and a control device 14. The three-dimensional printer 10 manufactures a three-dimensional object. The packing material manufacturing device 12 manufactures a packing material for packing the three-dimensional object. The control device 14 communicates with both the three-dimensional printer 10 and the packing material manufacturing device 12, and creates data of the packing material to be manufactured with the packing material manufacturing device 12 based on data used for the manufacturing of the three-dimensional object in the three-dimensional printer 10. The control device 14 may be a processing device integral with the three-dimensional printer 10 or the packing material manufacturing device 12, that is, same as the control function of the three-dimensional printer 10 or the packing material manufacturing device 12. Each section will be described below in order.

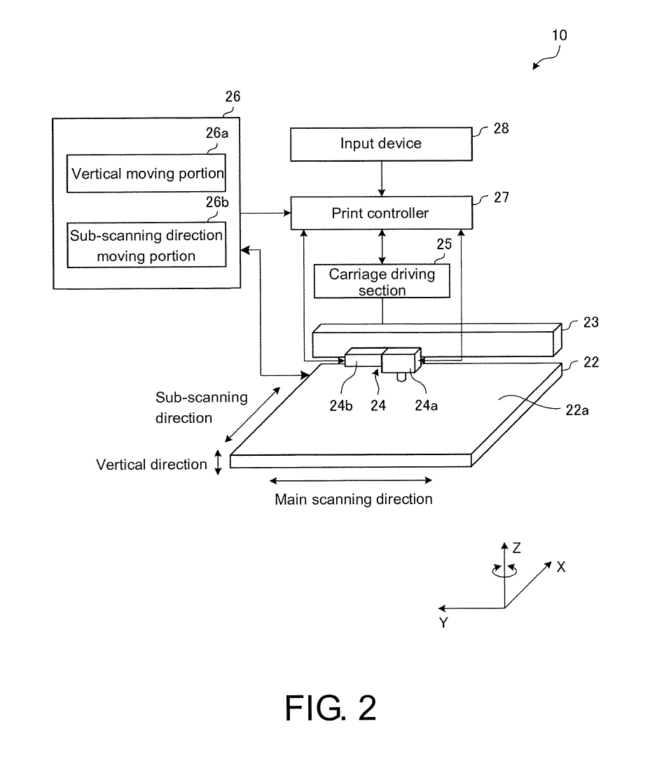

One example of an inkjet printer 10, which is the three-dimensional printer 10, will be described using FIG. 2. FIG. 2 is a schematic view showing a general configuration of an inkjet printer. The inkjet printer 10 serving as the three-dimensional printer according to the embodiment shown in FIG. 2 is a stereoscopic molding device that manufactures an object, which is a three-dimensional stereoscopic object, using a so-called inkjet method. The inkjet printer 10 typically divides an object into a plurality of layers in an up and down direction based on the three-dimensional data of the object, and stacks a molding material (obtained by curing ink) in order from the layer on the lower side based on shape data for each layer of the object W to form the object complying with the three-dimensional data.

As shown in FIG. 2, the inkjet printer 10 includes a mounting table 22 whose upper surface serves as a working plane 22a, a Y bar 23 arranged in a main scanning direction, a carriage 24, a carriage driving section 25 (corresponding to a reciprocating section), a mounting table driving section 26, a print controller 27, and an input device 28.

The working plane 22a of the mounting table 22 is a plane formed flat in a horizontal direction (direction parallel to both X axis and Y axis shown in FIG. 2), and on which ink serving as the molding material is stacked in order from the layer on the lower side. The mounting table 22 is, for example, formed to a substantially rectangular shape, but is not limited thereto.

The Y bar 23 is arranged with a predetermined spacing on a vertically upper side of the mounting table 22. The Y bar 23 is linearly arranged along the main scanning direction parallel to the horizontal direction (Y axis). The Y bar 23 guides the reciprocating movement of the carriage 24 along the main scanning direction.

The carriage 24 is held by the Y bar 23, and can reciprocate in the main scanning direction along the Y bar 23. The carriage 24 is movement-controlled in the main scanning direction. The carriage 24 includes a discharging portion 24a and an ultraviolet ray irradiator 24b by way of a holder (not shown), and the like on a surface facing the mounting table 22 with respect to the vertical direction.

The discharging portion 24a discharges ink serving as a molding material, the cure degree of which changes by exposure, onto the working plane 22a. The discharging portion 24a of the embodiment at least discharges the ink that forms the object as an ink, the cure degree of which changes by exposure. The discharging portion 24a may include a plurality of discharging nozzles (not shown) arranged on the carriage 24, and capable of discharging ink stored in an ink tank (not shown) onto the working plane 22a. The plurality of discharging nozzles are arranged along a longitudinal direction of the Y bar 23, that is, the main scanning direction.

The discharging portion 24a can reciprocate along the main scanning direction with the movement of the carriage 24 along the main scanning direction. The discharging nozzle of the discharging portion 24a is connected to an ink tank by way of various types of ink flow paths, a regulator, a pump, and the like. The discharging nozzle of the discharging portion 24a is arranged singularly or in plurals according to the number of ink tanks, that is, number of types of ink that can be simultaneously printed, and the like. The discharging nozzle of the discharging portion 24a is an inkjet head capable of discharging the ink in the ink tank toward the working plane 22a through the inkjet method. For the ink, the cure degree of which changes by exposure, for example, UV (ultraviolet) curable ink that cures when irradiated with an ultraviolet ray can be used, and for example, white ink, coloring ink, transparent ink, and the like can be appropriately used according to a hue of the object to be manufactured. The discharging portion 24a is electrically connected to the print controller 27, the drive of which is controlled by the print controller 27.

The ultraviolet ray irradiator 24b can expose the ink discharged to the working plane 22a to light. The ultraviolet ray irradiator 24b is, for example, configured by an LED module, and the like capable of emitting an ultraviolet ray. The ultraviolet ray irradiator 24b is arranged on the carriage 24, and can reciprocate along the main scanning direction with the movement of the carriage 24 along the main scanning direction. The ultraviolet ray irradiator 24b is electrically connected to the print controller 27, the drive of which is controlled by the print controller 27.

The carriage driving section 25 is a driving device that relatively reciprocates (scans) the carriage 24, that is, the discharging portion 24a in the main scanning direction with respect to the Y bar 23. The carriage driving section 25 is configured to include, for example, a transmission mechanism such as a transportation belt coupled to the carriage 24, and a drive source such as an electrical motor for driving the transportation belt, and converts a power generated by the drive source to a power for moving the carriage 24 along the main scanning direction through the transmission mechanism and reciprocates the carriage 24 along the main scanning direction. The carriage driving section 25 is electrically connected to the print controller 27, the drive of which is controlled by the print controller 27.

As shown in FIG. 2, the mounting table driving section 26 includes a vertical moving portion 26a and a sub-scanning direction moving portion 26b. The vertical moving portion 26a moves the mounting table 22 up and down along the vertical direction parallel to a Z axis to relatively move the working plane 22a formed on the mounting table 22 up and down in the vertical direction with respect to the discharging portion 24a. The mounting table driving section 26 thus can move the working plane 22a toward or away the discharging portion 24a, the ultraviolet ray irradiator 24b, and the like in the vertical direction. That is, the mounting table driving section 26 can relatively move the working plane 22a along the vertical direction with respect to the discharging portion 24a and the ultraviolet ray irradiator 24b.

The sub-scanning direction moving portion 26b moves the mounting table 22 in the sub-scanning direction parallel to the X axis orthogonal to the main scanning direction to relatively reciprocate the working plane 22a formed on the mounting table 22 along the sub-scanning direction with respect to the discharging portion 24a. The mounting table driving section 26 thus can reciprocate the working plane 22a along the sub-scanning direction with respect to the discharging portion 24a, the ultraviolet ray irradiator 24b, and the like. That is, the sub-scanning direction moving portion 26b can relatively reciprocate the discharging portion 24a and the ultraviolet ray irradiator 24b, and the working plane 22a in the sub-scanning direction. In the embodiment, the sub-scanning direction moving portion 26b moves the mounting table 22 in the sub-scanning direction, but the present disclosure is not limited thereto, and may move the discharging portion 24a and the ultraviolet ray irradiator 24b in the sub-scanning direction together with every Y bar 23.

The axis center rotating portion 26c rotates the mounting table 22 about an axis center (Z axis) parallel to the vertical direction to relatively rotate the working plane 22a formed on the mounting table 22 about the axis center with respect to the discharging portion 24a. The mounting table driving section 26 thus can rotate the working plane 22a about the axis center with respect to the discharging portion 24a, the ultraviolet ray irradiator 24b, and the like. That is, the axis center rotating portion 26c can freely rotate the working plane 22a about the axis center (Z axis) parallel to the vertical direction.

The print controller 27 controls each section of the inkjet printer 10 including the discharging portion 24a, the ultraviolet irradiator 24b, the carriage driving section 25, the mounting table driving section 26, and the like. When discharging and molding by moving (scanning) the discharging portion 24a in one direction from one edge toward the other edge of the object, the print controller 27 discharges the ink such that the landed ink density become smaller from (along) one edge toward the other edge to mold the one edge. Furthermore, when discharging and molding by moving (scanning) the discharging portion 24a in another direction opposite to the above one direction, the print controller 27 discharges the ink such that the landed ink density becomes smaller from (along) the other edge toward the one edge to mold the other edge. In other words, the print controller 27 discharges the ink while moving the discharging portion 24a in the main scanning direction from an outer side toward an inner side of a non-molded outer surface of the object to mold an edge including the outer surface.

The print controller 27 is configured by hardware such as an arithmetic device and a memory and a program for realizing predetermined functions thereof. The print controller 27 controls the discharging portion 24a to control discharging amount, discharging timing, discharging period, and the like of the ink (molding ink). The print controller 27 controls the ultraviolet ray irradiator 24b to control intensity, exposure timing, exposure period, and the like of the ultraviolet ray to be emitted. The print controller 27 controls the carriage driving section 25 to control the relative movement along the main scanning direction of the carriage 24. The print controller 27 controls the mounting table driving section 26 to control the relative movement of the mounting table 22 along the vertical direction and the sub-scanning direction.

The input device 28 is connected to the print controller 27, and is provided to input three-dimensional data related to the shape of the object. The input device 28 is, for example, configured by PC, various terminals, and the like wire/wireless-connected to the print controller 27.

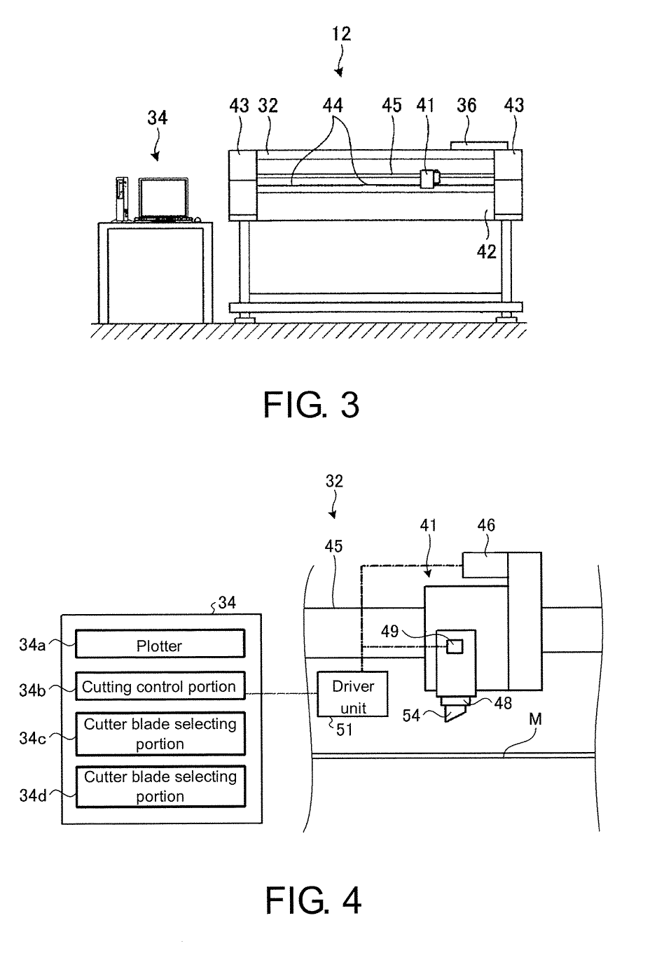

The packing material manufacturing device 12 will now be described using FIGS. 3 and 4. FIG. 3 is a schematic view showing a general configuration of a packing material manufacturing device. FIG. 4 is a schematic view showing a configuration of each section of the packing material manufacturing device. The packing material manufacturing device 12 is a cutting device, and processes a plate-shaped medium M to form a void or a cutout at one part, thus manufacturing the shock absorbing material to dispose at the periphery of the three-dimensional object. The packing material manufacturing device 12 manufactures a member to become a container box by processing the medium M and assembling after the processing. That is, the packing material manufacturing device 12 manufactures the container box before the assembly, and the plate-shaped shock absorbing material to become a protective member for protecting the three-dimensional object by stacking.

The packing material manufacturing device 12 includes a cutting plotter 32, and a computer 34 connected to the cutting plotter 32. The cutting plotter 32 has a cutter unit 41 with a holder 48 for attaching various types of cutter blades 54. The cutter unit 41 is disposed to face a platen 42, which serves as a supporting table of a medium M, in the Z axis direction. In other words, the cutter unit 41 is disposed above the platen 42 at a position away from the upper surface of the platen 42. The platen 42 is a plane parallel to the X axis and the Y axis directions, where the medium M is placed on the upper surface thereof.

The cutter unit 41 includes a mechanism (tangential mechanism) for adjusting the direction of the cutter blade 54, a mechanism (reciprocating mechanism) for cutting the medium M by vibrating the cutter blade 54 vertically in the Z axis direction, and a mechanism for lifting and lowering the cutter blade 54 vertically in the Z axis direction in order to adjust the clearance between the medium M and the cutter blade 54. The cutter unit 41 further includes an X axis driving mechanism and a Y axis driving mechanism. The Y axis driving mechanism is built in the unit 43 of FIG. 3 and moves the cutter unit 41 in the left-right direction (Y axis direction) of FIG. 3 by a timing belt (not shown) arranged parallel to a guide rail 45 that extends in the left-right direction (Y axis direction) of FIG. 3. The timing belt of the Y axis driving mechanism is driven by a motor or the like connected via a transmission mechanism. Moreover, the X axis driving mechanism is built in the unit 43 of FIG. 3 and moves the guide rail 45 and the cutter unit 41 in the front-rear direction (depth direction, X axis direction) of FIG. 3 by a timing belt (not shown). Thus, the cutter unit 41 can realize oblique movement above the platen 42 by simultaneously operating the X axis driving mechanism and the Y axis driving mechanism.

The holder 48 operates when the vertical movement in the Z axis direction is controlled by a rack and pinion mechanism 46. The holder 48 has a mechanism 49 for control to direct a cutting edge portion of the cutter blade 54 to the moving direction of the cutter unit 41. In the holder 48, the mechanism for cutting the medium M by vibrating the cutter blade 54 vertically in the Z axis direction includes an eccentric cam that is in contact with the cutter blade 54, a spring that biases the cutter blade 54 against the eccentric cam, and a driving source that rotates the eccentric cam. The vertical movement of the cutter blade 54 is performed by upward and downward power that is transmitted to the cutter blade 54 with the holder 48 as a fulcrum through rotation of the eccentric cam. While the cutter unit 41 is moved by the X axis driving mechanism and the Y axis driving mechanism, the cutter unit 41 is moved vertically with the cutting edge portion of the cutter blade 54 of the cutter unit 41 directed to the moving direction, so as to cut the medium M.

The cutter unit 41 of the present embodiment is a tangential type cutter (tangential cutter) that is provided with the mechanism 49 and controls the direction of the cutter blade 54 and controls the direction of the cutting edge to be in the traveling direction with the rotation mechanism, e.g., motor, and cuts the medium M, but it may also have a structure without the driving source that controls the direction of the cutter blade 54. In addition, the cutter unit 41 of the present embodiment uses a reciprocating cutter that fixes the angle of the cutter blade 54 at a predetermined angle to achieve high-speed vertical movement, but it can also use a dragging-type cutter that does not fix the angle of the cutter blade 54 at a predetermined angle and moves the medium M and the cutter blade 54 relatively to cut the medium M. In this case, the holder 48 has a structure rotatable around the Z axis and rotates following the movement of the cutter unit 41 in the X and Y directions. For the holder 48 having such a structure, in order to direct the cutter blade 54 to the cutting direction, it is necessary to perform an operation, that is, the so-called discarding cutting. The discarding cutting is an operation of cutting a straight cutting line of around 5mm in an unused part, such as a corner, of the medium M and thereby directing the cutter blade 54 to the direction of the cutting line. In the present embodiment, the direction of the cutter blade 54 is set as the direction of the discarding cutting operation.

The cutting plotter 32 includes a controller 36 that controls the cutting plotter 32. The controller 36 and the computer 34 integrally carry out information processing of the packing material manufacturing device 12, and with a predetermined program stored in the hardware of the controller 36 and the computer 34, configure a plotter 34a that plots the cutting target object on the medium M, a cutting control portion 34b that carries out processing of the medium M according to a processing path, a processing path generator 34c that generates the processing path of the cutting target object S, a cutter blade selecting portion 34d for selecting the cutter blade to use for the cutting from a plurality of registered cutter blades, a non-cutting portion setting portion that sets a non-cutting portion on a line segment, and a non-cutting portion processing path generator that generates a processing path by the selected cutter blade 54 of the non-cutting portion. Moreover, the cutting control portion 34b is connected to the driver unit 51 that controls the directions and vibrations of the X axis driving mechanism, the Y axis driving mechanism, and the holder 48 built in the unit 43 of FIG. 3.

The computer 34 is connected to the cutting plotter 32 by a dedicated cable such as a USB cable and an RS-232C, a network, and a wireless short-distance communication. The computer 34 may take a resource form built in the Internet space.

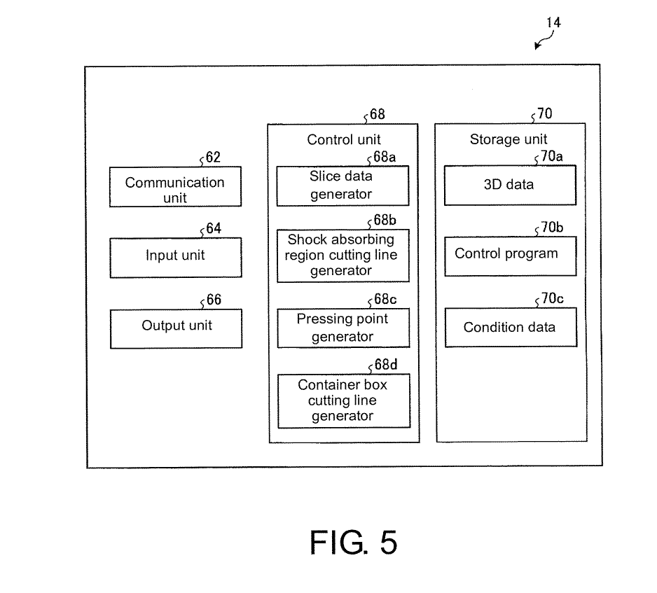

A configuration of the control device 14 will now be described using FIG. 5. FIG. 5 is a schematic view showing a general configuration of a control device. The control device 14 includes a communication unit 62, an input unit 64, an output unit 66, a control unit 68, and a storage unit 70. The communication unit 62 communicates with the three-dimensional printer 10 and the packing material manufacturing device 12 in a wired or wireless manner to transmit and receive data. The input unit 64 is a device to which the user inputs operation such as a keyboard, a touch panel, a mouse, and the like. The input unit 64 may include a reading device for reading a recording medium. The output unit 66 is a device that outputs an operation result, an input screen, an arithmetic result, and the like to the user such as a liquid crystal display, a printer, a speaker and the like.

The control unit 68 is an arithmetic device that includes a CPU and that carries out various types of arithmetic processes. The control unit 68 includes a slice data generator 68a, a shock absorbing region cutting line generator 68b, a pressing point generator 68c, and a container box cutting line generator 68d. The slice data generator 68a performs a process of dividing while moving a cutting plane in a direction orthogonal to the cutting plane with respect to the three-dimensional data, which is the shape data of the three-dimensional object, and creates data in which the three-dimensional object is divided at a parallel cutting plane. With each layer divided at the cutting plane as a shape of one layer to form, the three-dimensional printer 10 creates the shape of each layer in order, thereby manufacturing the three-dimensional object. The slice data generator 68a may acquire the slice data from the three-dimensional printer 10. The shock absorbing region cutting line generator 68b generates a shock absorbing region cutting line, which is a line for cutting the shock absorbing material, based on the three-dimensional data or the slice data, or slice data in the present embodiment. The shock absorbing region cutting line becomes a contour line on the inner side of the shock absorbing material determined in correspondence with the shape of the three-dimensional object. In the shock absorbing material, the contour line on the inner side faces the three-dimensional object when packing the three-dimensional object. The pressing point generator 68c adds a pressing point (pressing position) that makes contact with the three-dimensional object in the shock absorbing region cutting line when packing the three-dimensional object. The container box cutting line generator 68d generates a cutting line for manufacturing a container box, which is a box for accommodating the three-dimensional object covered with the shock absorbing material. That is, the container box cutting line generator 68d generates a cutting line of a plate material having a shape to become the container box when assembled based on the size of the shock absorbing material and the three-dimensional object.

The storage unit 70 is a storage device for storing data, and stores 3D data (three-dimensional data) 70a, control program 70b, and condition data 70c. The 3D data (three-dimensional data) 70a is shape data of the three-dimensional object. The 3D data 70a stores the shape data of a plurality of three-dimensional objects manufactured with the three-dimensional printer 10. The 3D data 70a may be stored including the slice data. The control program 70b is a program that executes an arithmetic process of each portion of the control unit 68. The control unit 68 can realize various types of processes by reading out the control program 70b from the storage unit 70, and executing the control program. The condition data 70c stores a threshold value and a processing condition of an operation executed by the control program 70b.

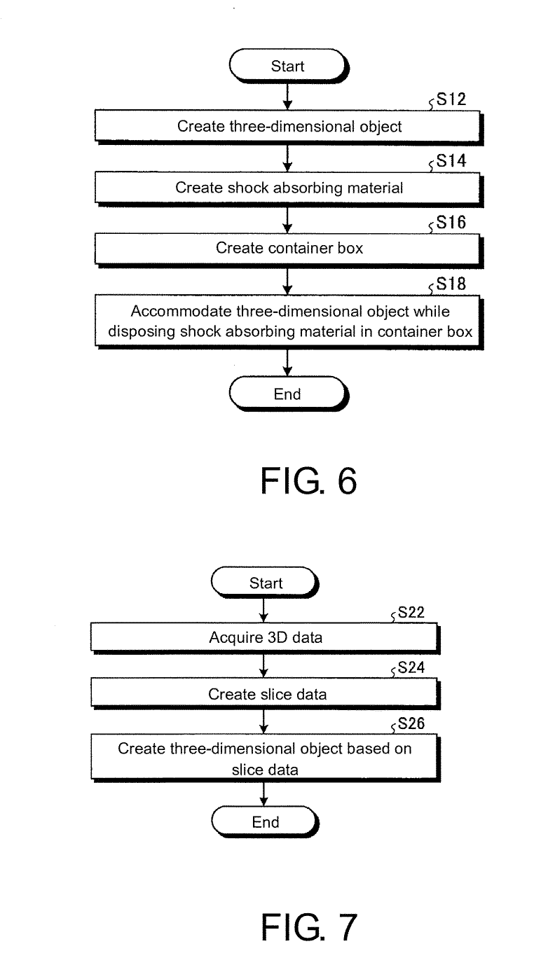

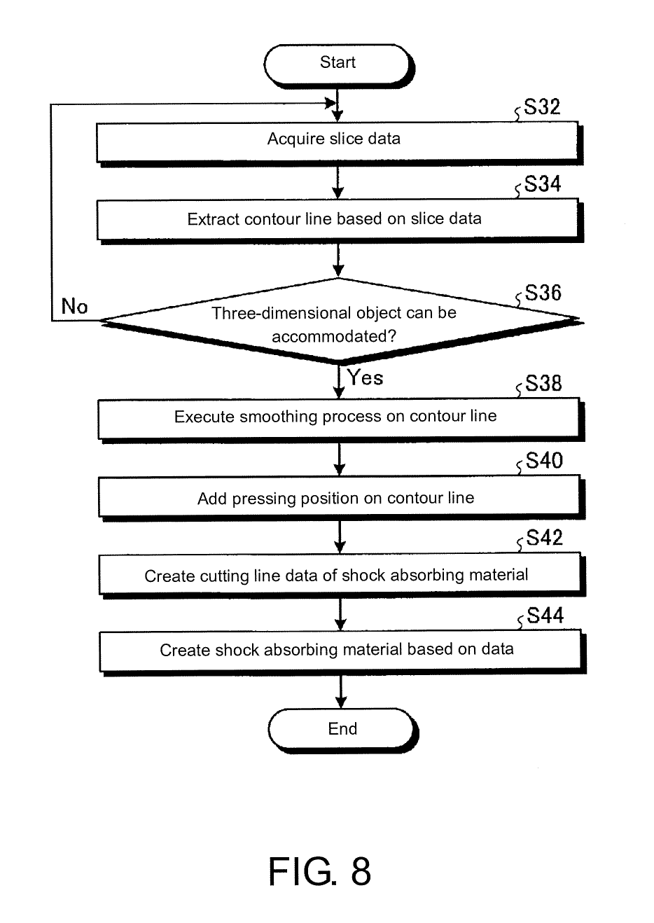

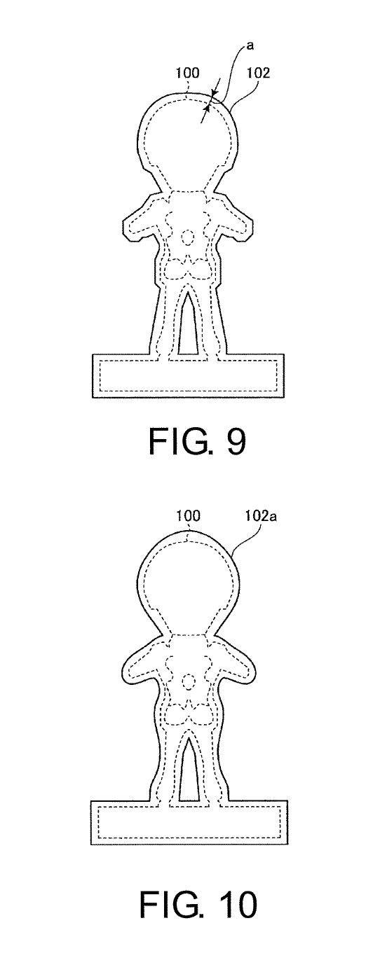

One example of a processing operation of the three-dimensional object manufacturing system, that is, a three-dimensional object manufacturing method will be described below using FIGS. 6 to 12. FIG. 6 is a flowchart showing one example of a processing operation of a three-dimensional object manufacturing system. FIG. 7 is a flowchart showing one example of a method for manufacturing a three-dimensional object. FIG. 8 is a flowchart showing one example of a method for manufacturing a shock absorbing material. FIGS. 9 to 11 are respectively explanatory views for describing the method for manufacturing the shock absorbing material. FIG. 12 is a flowchart showing one example of a method for manufacturing a container box.

The entire process will be described using FIG. 6. The three-dimensional object manufacturing system 1 creates a three-dimensional object with the three-dimensional printer 10 (step S12). Next, the three-dimensional object manufacturing system 1 creates a shock absorbing material with the packing material manufacturing device 12 (step S14). Then, the three-dimensional object manufacturing system 1 creates a container box with the packing material manufacturing device 12 (step S16). The order of processes of step S12, step S14, and step S16 may be changed. The shock absorbing material and the container box may be created with the same packing material manufacturing device 12 or may be created with different packing material manufacturing devices 12. After the three-dimensional object, the shock absorbing material, and the container box are created, the container box is assembled, and the three-dimensional object is accommodated in the container box while disposing the shock absorbing material (step S18). Thus, the three-dimensional object can be manufactured, and accommodated in the container box while protecting the manufactured three-dimensional object with the shock absorbing material.

Each process will be described below. One example of a method for manufacturing the three-dimensional object will be described using FIG. 7. The three-dimensional printer 10 acquires three-dimensional data (3D data) of the three-dimensional object to manufacture (step S22). The three-dimensional printer 10 creates the slice data based on the acquired three-dimensional data (step S24). The slice data is data obtained by cutting the three-dimensional object at the parallel cutting plane to manufacture as described above and separating the same to each layer at the time of manufacturing. The three-dimensional printer 10 creates the three-dimensional object based on the slice data (step S26).

A method for manufacturing the shock absorbing material will now be described using FIGS. 8 to 11. The process shown in FIG. 8 can be realized when the packing material manufacturing device 12 and the control device 14 execute the processes. The control device 14 acquires the slice data of the three-dimensional object (step S32). The control device 14 may create the slice data from the data of the three-dimensional shape of the three-dimensional object or may acquire the slice data created with the three-dimensional printer. The control device 14 determines the shape of the shock absorbing material, specifically, the shape of the region on the side to surround the three-dimensional object based on the acquired slice data.

The control device 14 extracts a contour line based on the slice data (step S34). Specifically, as shown in FIG. 9, with a three-dimensional object 100 as a reference, positions spaced apart by a distance a from the three-dimensional object 100 are connected to create a contour line 102 that covers the entire outer periphery of the three-dimensional object 100. The contour line 102 thereby becomes a line that maintains the distance a from the three-dimensional object 100, and in which the distance from the three-dimensional object 100 is constant. The control device 14 assumes that the position of the contour line 102 in a thickness direction of the shock absorbing material is the same position. The control device 14 calculates the contour line 102 based on a position on an outermost side in the thickness direction of the shock absorbing material of the slice data. The control device 14 carries out a similar process for each layer of the slice data, and creates the contour line 102 of a plurality of layers that surrounds the periphery of the three-dimensional object 100.

After creating the contour line 102, the control device 14 determines whether or not the three-dimensional object 100 can be accommodated (step S36). The control device 14 determines whether or not the shock absorbing material created with the contour line 102 can be disposed with respect to the three-dimensional object. For example, when disposing one layer of the shock absorbing material for the three-dimensional object, determination is made that the three-dimensional object cannot be accommodated if the portion having a larger diameter than the inner diameter of the contour line of the shock absorbing material in the three-dimensional object needs to be passed. When determining that the three-dimensional object cannot be accommodated (No in step S36), the control device 14 returns to step S32, creates the slice data with the direction of the cutting plane with respect to the three-dimensional object changed, and carries out the processes of step S32 to step S36.

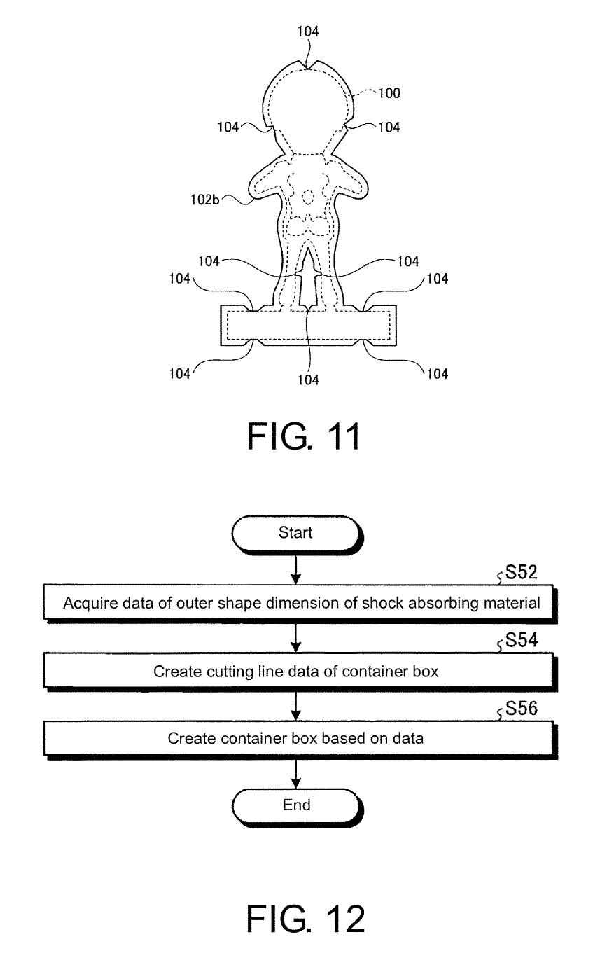

When determining that the three-dimensional object 100 can be accommodated (Yes in step S36), the control device 14 executes a smoothing process on the contour line 102 (step S38). Specifically, the control device 14 carries out the smoothing process on the contour line 102 to create a contour line 102a connected with a smooth line, as shown in FIG. 10. After carrying out the smoothing process, the control device 14 adds a pressing position on the contour line 102a (step S40). The pressing position is the position where the three-dimensional object and the shock absorbing material make contact. As shown in FIG. 11, the control device 14 creates a contour line 102b including the pressing position 104 at plural locations in the periphery of the three-dimensional object 100. The pressing position 104 is preferably provided at a location where the thickness of the three-dimensional object 100 is large, that is, a location less likely to be damaged. Furthermore, the control device 14 preferably provides the pressing position 104 on the contour line 102b in a dispersed manner, thus obtaining a state in which the shock absorbing material can support the three-dimensional object 100 from a plurality of directions. The control device 14 analyzes the three-dimensional data of the three-dimensional object 100, and provides a pressing position at the position 104, which is a location less likely to be damaged and at which the three-dimensional object 100 can be supported from a plurality of directions at the periphery. The pressing position is preferably connected with a plurality of layers of the shock absorbing material. The three-dimensional object 100 thus can be suitably supported. The smoothing process is preferably performed to prevent a microscopic expressing part of the three-dimensional object 100 from getting caught at the shock absorbing material during the packing work and suppress the damage of the three-dimensional object 100, but the smoothing process may not be performed.

After adding the pressing position, the control device 14 creates the cutting line data of the shock absorbing material based on the created contour line 102b (step S42). That is, the contour line 102b calculated in each layer is set as the cutting line data of the shock absorbing material.

The packing material manufacturing device 12 creates the shock absorbing material based on the created cutting line data of the shock absorbing material (step S44). That is, the original material of the plate shaped shock absorbing material is cut based on the cutting line data of the shock absorbing material to create the shock absorbing material to become the outer peripheral shape corresponding to the cutting line data of the shock absorbing material. The packing material manufacturing device 12 creates the shock absorbing material of each layer based on the cutting line data of the shock absorbing material corresponding to the shape of the shock absorbing material for a plurality of layers. The shock absorbing material that surrounds the periphery of the three-dimensional object is thereby manufactured.

In the present embodiment, the distance between the three-dimensional object 100 and the shock absorbing material can be separated, and hence the cutting line data of the shock absorbing material is created based on the contour line 102 obtained by connecting the positions spaced apart by the distance a from the three-dimensional object 100 with the slice data of the three-dimensional object 100 as a reference, but this is not the sole case. The packing material manufacturing device 12 may use the slice data of the three-dimensional object 100 as the cutting line data. With the slice data of the three-dimensional object 100 as a reference, the packing material manufacturing device 12 may create the cutting line data having a position moved toward the three-dimensional object 100 side to be smaller by a predetermined distance than the slice data, as a cutting line. Furthermore, the packing material manufacturing device 12 may create, with the slice data as the reference, the cutting line data in which at least two of a portion having a position spaced apart by a predetermined distance from the slice data as a contour line, a portion having a position of the slice data as a contour line, and a portion having a position moved toward the three-dimensional object 100 side by a predetermined distance from the slice data as a contour line, are combined according to the position.

A method for manufacturing the container box will now be described using FIG. 12. The process shown in FIG. 12 can be realized when the packing material manufacturing device 12 and the control device 14 execute the processes. The control device 14 acquires data of an outer shape dimension of the shock absorbing material (step S52). The outer shape dimension of the shock absorbing material is a dimension of an outer shape of the multi-layered shock absorbing material in a state of being overlapped on the surface of the three-dimensional object. The control device 14 creates the cutting line data of the container box based on the outer shape dimension (step S54). Specifically, the container box that can accommodate the shock absorbing material is designed based on the outer shape dimension of the shock absorbing material, and a development view of the container box is created. In the development view, a region that is overlapped when assembling the container box, and that becomes an adhering surface is also formed. The packing material manufacturing device 12 creates the container box based on the cutting line data (step S56). Specifically, the packing material manufacturing device 12 creates a member in a state the container box is developed based on the cutting line data. The member created with the packing material manufacturing device 12 can be bent and assembled to create the container box.

As described above, the three-dimensional object manufacturing system 1 can create the shock absorbing material that lies along the shape of the three-dimensional object by determining the shape of the shock absorbing material based on the three-dimensional data used when manufacturing the three-dimensional object, and creating the shock absorbing material based on the determined shape of the shock absorbing material. The shock absorbing material thus can be suitably disposed at the periphery of the three-dimensional object, and the three-dimensional object can be protected with the shock absorbing material. The load thus can be suppressed from concentrating at one part of the three-dimensional object, and the three-dimensional object can be protected. Furthermore, the three-dimensional object manufacturing system 1 can easily create the shock absorbing material that can suitably protect the three-dimensional object because the shape of the shock absorbing material can be automatically calculated by calculating the shape of the shock absorbing material using the three-dimensional data.

The three-dimensional 3D manufacturing system 1 can suitably protect the three-dimensional object with the shock absorbing material by forming the shock absorbing material to a shape that covers the entire outer periphery of the three-dimensional object.

The three-dimensional object manufacturing system 1 can appropriately calculate the shape of the respective layers of the multi-layered shock absorbing material by using the slice data of the three-dimensional object. The control device 14 can efficiently acquire the slice data and reduce the overall computation amount by acquiring the slice data created with the three-dimensional printer, that is, the slice data used for the manufacturing of the three-dimensional object.

The control device 14 can realize a smooth shape for the contour line by performing the smoothing process on the contour line. The shock absorbing material thus can be easily manufactured.

Furthermore, the control device 14 can more appropriately support the three-dimensional object with the shock absorbing material by providing the pressing position (contacting portion) of making contact with the three-dimensional object in the shock absorbing material. The control device 14 can also suppress the damage of the contacting position even in a state where the shock absorbing material is making contact with the three-dimensional object by having a position with high strength as the pressing position. The three-dimensional object thus can be protected with the shock absorbing material.

The control device 14 can more reliably support the three-dimensional object by providing the pressing position (contacting portion) of making contact with the three-dimensional object in the shock absorbing material, but a projection to become the pressing position may not be provided. Furthermore, the three-dimensional object manufacturing system 1 may have the shock absorbing material at the pressing position as a different member. That is, after installing the shock absorbing material lying along the contour line at the periphery of the three-dimensional object, a different shock absorbing material may be disposed between the shock absorbing material lying along the contour line and the three-dimensional object. In this case, the control device 14 preferably displays the portion corresponding to the pressing position, and indicates a position to insert a different member.

The control device 14 preferably provides a shock absorbing material, which does not have the slice data, at the upper end and the lower end in the stacking direction, in addition to the shock absorbing material to process, based on the slice data. Thus, by arranging the shock absorbing material of sandwiching the slice data in the stacking direction of the shock absorbing material, the three-dimensional object can be sandwiched with the shock absorbing material, and the three-dimensional object can be more safely protected.

The three-dimensional object manufacturing system 1 can suitably protect the shock absorbing material with the container box by calculating the shape of the container box based on the data of the shock absorbing material. The shock absorbing material having a stacked structure thus can be supported with the container box, and a recess shape for suitably supporting the three-dimensional object with the shock absorbing material can be formed.

The three-dimensional object manufacturing system 1 creates the shape of the shock absorbing material based on the data of the shape of the three-dimensional object, but molding data or various three-dimensional data created based on the shape data of the three-dimensional structural object merely needs to be used. The molding data includes, in addition to the shape data of the three-dimensional object, various three-dimensional shape data created based on the shape of the three-dimensional object such as shape data of a support layer (member disposed at the periphery of the three-dimensional structural object) created based on the shape of the three-dimensional object.

The three-dimensional object manufacturing system 1 manufactures the container box and the shock absorbing material with the packing material manufacturing device 12, but merely needs to manufacture the shock absorbing material and may not manufacture the container box. The container box, for example, may be a commercially available box. In this case, the packing material manufacturing device 12 can appropriately dispose the shock absorbing material in the container box by acquiring the shape data of the container box, and designing the width on the outer peripheral side of the shock absorbing material and the thickness of the stacked shock absorbing material in accordance with the shape of the container box.

In the present embodiment, the three-dimensional printer 10 adopts a method of discharging the ultraviolet curing-type ink through the inkjet, but this is not the sole case. The three-dimensional printer 10 can use a manufacturing device of various types of methods for manufacturing the three-dimensional object. For example, the 3D printer 10 may adopt a method of dissolving a filament for molding (FDM), a plaster method of curing powder plaster with an adhesive, an optical shaping method of irradiating a liquid tank of optically shaping resin with curing light, and the like.

What is claimed is:

1. A three-dimensional object manufacturing system comprising:
a three-dimensional structural object manufacturing device that manufactures a three-dimensional object based on forming data of the three-dimensional object;
a packing material manufacturing device that manufactures a shock absorbing material that is disposed at a periphery of the three-dimensional object and that is detachably attached to the three-dimensional object; and
a control device that calculates a shape of the shock absorbing material based on the forming data of the three-dimensional object.

2. The three-dimensional object manufacturing system according to claim 1, wherein the control device has the shape of the shock absorbing material to a shape that covers an entire periphery of the three-dimensional object.

3. The three-dimensional object manufacturing system according to claim 1, wherein the control device calculates a first outer shape of a distance set from the three-dimensional object based on the molding data of the three-dimensional object, and carries out a smoothing process on the first outer shape and calculates a second outer shape, and calculates the shape of the shock absorbing material based on the second outer shape.

4. The three-dimensional object manufacturing system according to claim 2, wherein the control device calculates a first outer shape of a distance set from the three-dimensional object based on the molding data of the three-dimensional object, and carries out a smoothing process on the first outer shape and calculates a second outer shape, and calculates the shape of the shock absorbing material based on the second outer shape.

5. The three-dimensional object manufacturing system according to claim 1, wherein the control device causes the shape of the shock absorbing material to be a shape in which one part of the shock absorbing material and the three-dimensional structural object make contact, based on the forming data of the three-dimensional object.

6. The three-dimensional object manufacturing system according to claim 2, wherein the control device causes the shape of the shock absorbing material to be a shape in which one part of the shock absorbing material and the three-dimensional structural object make contact, based on the forming data of the three-dimensional object.

7. The three-dimensional object manufacturing system according to claim 3, wherein the control device causes the shape of the shock absorbing material to be a shape in which one part of the shock absorbing material and the three-dimensional structural object make contact, based on the forming data of the three-dimensional object.

8. The three-dimensional object manufacturing system according to claim 1, wherein the control device calculates a shape of a plate-shaped shock absorbing material of each layer with the shape of the shock absorbing material as a shape in which the plate-shaped shock absorbing material is stacked in plurals; and
the packing material manufacturing device manufactures the plate-shaped shock absorbing material for a plurality of layers based on the shape of the shock absorbing material calculated with the control device.

9. The three-dimensional object manufacturing system according to claim 2, wherein the control device calculates a shape of a plate-shaped shock absorbing material of each layer with the shape of the shock absorbing material as a shape in which the plate-shaped shock absorbing material is stacked in plurals; and
the packing material manufacturing device manufactures the plate-shaped shock absorbing material for a plurality of layers based on the shape of the shock absorbing material calculated with the control device.

10. The three-dimensional object manufacturing system according to claim 3, wherein the control device calculates a shape of a plate-shaped shock absorbing material of each layer with the shape of the shock absorbing material as a shape in which the plate-shaped shock absorbing material is stacked in plurals; and
the packing material manufacturing device manufactures the plate-shaped shock absorbing material for a plurality of layers based on the shape of the shock absorbing material calculated with the control device.

11. A three-dimensional object manufacturing method comprising:
a three-dimensional structural object manufacturing step of manufacturing a three-dimensional object based on forming data of the three-dimensional object;
a calculating step of calculating a shape of a shock absorbing material that is disposed at a periphery of the three-dimensional object and that is detachably attached to the three-dimensional object; and
a shock absorbing material manufacturing step of manufacturing the shock absorbing material based on the calculated shape of the shock absorbing material.
